(19) United States
(12) Patent Application Publication
(10) Pub. No.: US 2014/0101530 A1
(43) Pub. Date: Apr. 10, 2014

(54) WEB BROWSING SYSTEM FOR CONTENT BROWSING

(71) Applicant: Lim Yong Tah Bryan, (US)

(72) Inventor: Lim Yong Tah Bryan, Singapore (SG)

(21) Appl. No.: 13/645,470

(22) Filed: Oct. 4, 2012

(51) Int. Cl. G06F 17/21

(52) U.S. Cl. CPC G06F 17/218
USPC 715/234

(57) ABSTRACT

A web browsing system and method is provided for mobile devices. The web browsing system includes an extractor module for extracting content available on a web page. In one embodiment, the content may include images. In another embodiment, the content may include text. The web browsing system further includes a display module for displaying the content on a display screen of a mobile device. The web browsing system further includes an organization module for organizing the extracted content based upon a property of the content. The web browsing system further includes a sync module configured to automatically synchronize the extracted content with new content offered by a website.

### BACKGROUND

1. Field of the Invention

Embodiments of the present invention generally relate to web browsing and particularly to browsing of images and text embedded on a web page.

2. Description of Related Art

Today, many worldwide web pages are available that offer plenty of viewable images. Specifically, e-commerce websites offer an abundance of viewable images. The images typically depict lists of available products for sale. Further, each product may have many images covering different angles of the product to help an online user in viewing the product completely before buying. When the user identifies a product of interest, then he/she can read the details associated with the image of that product and select that image for further details about the product. These images are easily arranged and displayed on a traditional desktop or laptop computer running a standard web browser as they have a large screen.

However today, the field of communications, and more specifically wireless telecommunications, is currently undergoing a radical expansion. This technological expansion allows an electronic device, such as mobile phone or other wireless portable electronic device to connect to the same information sources, such as a web server or database, as one could with the traditional desktop or laptop based browser. Several mobile browsers are available today which deliver content from the web to the mobile device.

However, mobile devices typically have a small screen and hence lack the screen space or navigation capabilities to display web content (for example, web content from an e-commerce website) intended for display on a traditional desktop or laptop computer.

Further, web browsers are the default application for browsing a web document from the Internet on a mobile device. Traditionally, users can only pan and zoom the mobile browser to read web documents. Web documents may contain images, texts and videos. Further, images may also be scattered everywhere within the web document. The difficulty of browsing images that are scattered everywhere within the web document may get increased with the length of the document due to small screen of the mobile device.

Further, the small screen size of the mobile devices also limits browsing of images from an e-commerce website. If a consumer has to pan around, pinch and expand an image of product, available for sale on the e-commerce website, in order to make a purchase, they're likely not going to do it. Without an e-commerce web site and shopping experience that's fully optimized for a mobile device, retailers risk losing the consumers who are shopping on their mobile devices. When a consumer encounters a website that isn't mobile optimized, they are increasingly likely to go to other sites that have optimized for mobile since, as there are a rapidly growing number of sites that are catering to the mobile experience. A good mobile shopping experience should be fully optimized for the smaller screen, should take advantage of touch screen technology and also should offer a fast checkout in as few steps as possible.

There is thus a need for an improved browsing system for mobile devices to easily browse images and text available on web pages of the e-commerce websites.

### SUMMARY

Embodiments in accordance with the present invention provide a web browsing system for mobile devices. The web browsing system includes an extractor module for extracting content available on a web page. In one embodiment, the content includes text. In another embodiment, the content includes images. The web browsing system further includes a display module for displaying the extracted content on a display screen of a mobile device. The web browsing system further includes an organization module for organizing the extracted content based upon a property of the content. The web browsing system further includes a sync module configured to automatically synchronize the extracted content stored on the web browsing system with a new content provided by a website.

Embodiments in accordance with the present invention further provide a method for browsing content of a webpage on mobile devices. In one embodiment, the content includes text. In another embodiment, the content includes images. The method includes extracting content available on a webpage. The method further includes displaying the content on a display screen of a mobile device. The method further includes organizing the extracted content based upon a property of the content. The method further includes converting the extracted content into a native photo album. The method further includes automatically synchronizing extracted content with a new content provided by a website.

Embodiments in accordance with the present invention further provide a computer readable medium having computer readable instructions which, when executed by a processor, cause the processor to perform a method for browsing content available on a webpage on a mobile device. In one embodiment, the content includes text. In another embodiment, the content includes images. The method includes extracting content available on the webpage. The method further includes displaying the content on a display screen of a mobile device.

These and other advantages will be apparent from the description of the invention(s) contained herein.

### BRIEF DESCRIPTION OF THE DRAWINGS

The above and still further features and advantages of the present invention will become apparent upon consideration of the following detailed description of embodiments thereof, especially when taken in conjunction with the accompanying drawings wherein like reference numerals in the various figures are utilized to designate like components, and wherein:

FIG. 1 is a block diagram depicting a network environment according to an embodiment of the present invention;

FIG. 2 is a block diagram depicting another network environment having a server according to an embodiment of the present invention;

FIG. 3 is a block diagram of a web browsing module according to an embodiment of the present invention; and

FIG. 4 is a flow chart depicting a method for browsing online content on a mobile device.

The headings used herein are for organizational purposes only and are not meant to be used to limit the scope of the description or the claims. As used throughout this application, the word “may” is used in a permissive sense (i.e., meaning having the potential to), rather than the mandatory sense (i.e., meaning must). Similarly, the words “include”, “including”, and “includes” mean including but not limited to. To facilitate understanding, like reference numerals have been used, where possible, to designate like elements common to the figures. Optional portions of the figures may be illustrated using dashed or dotted lines, unless the context of usage indicates otherwise.

### DETAILED DESCRIPTION

Illustrative embodiments of the invention now will be described more fully hereinafter with reference to the accompanying drawings, in which some, but not all embodiments of the invention may be shown. Indeed, the invention may be embodied in many different forms and should not be construed as limited to the embodiments set forth herein; rather, these embodiments may be provided so that this disclosure will satisfy applicable legal requirements. Like numbers refer to like elements throughout.

The invention will be illustrated below in conjunction with a mobile device. Although well suited for use with any electronic device, e.g., desktop computer, laptop, etc., the invention is not limited to any particular type of electronic device. Those skilled in the art will recognize that the disclosed techniques may be used in any electronic device in which it is desirable to browse images and texts.

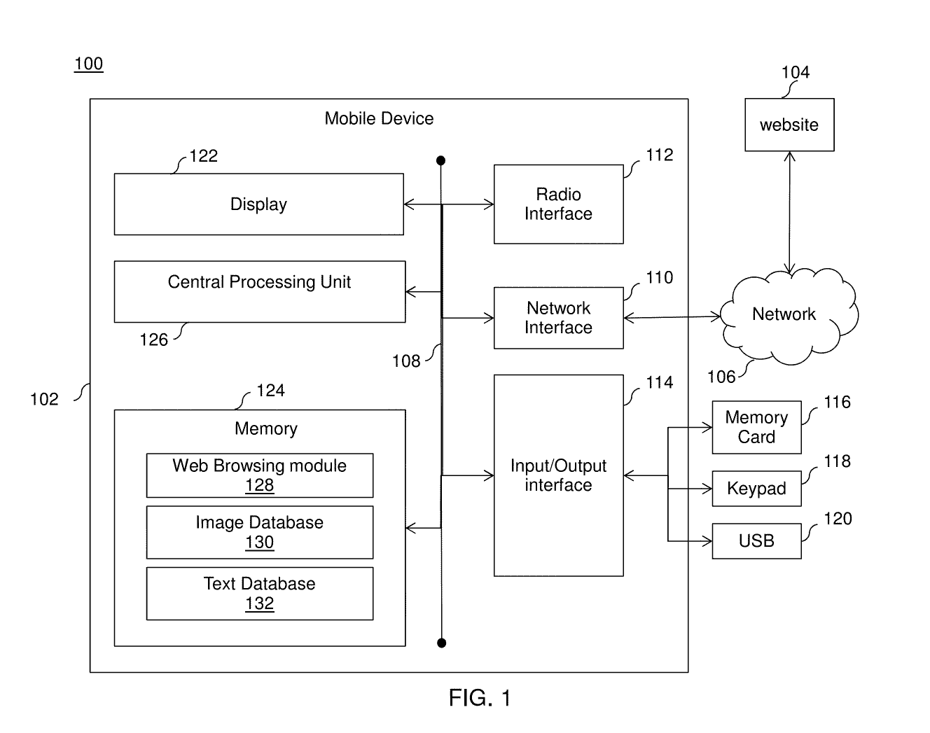

FIG. 1 illustrates an exemplary network environment 100 where various embodiments of the present invention may be implemented. The network environment 100 includes a mobile device 102 connected to a website 104 via a network 106. The Network 106 may include, but is not restricted to, a communication network such as Internet, PSTN, Local Area Network (LAN), Wide Area Network (WAN), Metropolitan Area Network (MAN), and so forth. In an embodiment, the network 106 can be a data network such as the Internet. Further, the messages exchanged between the mobile device 102 and the website 104 can comprise any suitable message format and protocol capable of communicating the information necessary for the mobile device 102 to display the content offered by the website 104.

FIG. 1 further illustrates exemplary block diagram of the mobile device 102, in accordance with an embodiment of the present invention. In an embodiment, the mobile device 102 may be utilized for browsing web pages offered by the website 104. In one embodiment, the website is an e-commerce website. In another embodiment, the website may be any other website available on Internet.

The mobile device 102 includes a system bus 108 to connect the various components. Examples of system bus 108 include several types of bus structures including a memory bus or memory controller, a peripheral bus, or a local bus using any of a variety of bus architectures. The mobile device 102 can be a telecommunication device such as, but not limited to, a telephone, a mobile phone, a smart-phone and so forth. The mobile device 102 may connect to the network 106 through a network interface 110. Further, the mobile device 102 can connect to PSTN (not shown in the Figure) through a radio interface 112. Input/Output (IO) interface 114 of device 100 may be configured to connect external or peripheral devices such as a memory card 116, a keypad 118 and a Universal Serial Bus (USB) device 120. Although not shown, various other devices may be connected through IO interface 114 to the mobile device 102. In an embodiment of the invention, the mobile device 102 may be connected to a hub device, which may provide various services such as voice communication, Internet access, television services and so forth. For example, the hub may be a Home Gateway device that acts as a hub between the home environment and the Broadband Network.

The mobile device 102 includes a display 122 to output graphical information to a user of the mobile device 102. In an embodiment of the invention, display 122 includes a touch sensitive screen. Therefore, the user can provide inputs to mobile device 102 by touching the display 122. Memory 124 of mobile device 102 stores various programs, data and/or instructions that can be executed by Central Processing Unit (CPU) 126. Examples of memory include, but are not limited to, a Random Access Memory (RAM), a Read Only Memory (ROM), a hard disk, and so forth. A person skilled in the art will appreciate that other types of computer-readable media which can store data that is accessible by a computer, such as magnetic cassettes, flash memory cards, digital video disks, and the like, may also be used by mobile device 102. Memory 124 may include Operating System (OS) (not shown) for the mobile device 102 to function. Further, memory 124 may include other applications (not shown in the figure) that enable the user to open web pages offered by the website. Other applications may be stored as software or firmware on the mobile device 102.

Further, memory 124 includes a shoppink browser (not shown in the FIG. 1), according to an embodiment of the present invention. The shoppink browser may include a web browsing module 128 for browsing web pages of destination websites. The web browsing module 128 may be an application stored as a software or firmware on the mobile device 102. In an embodiment, the web browsing module 102 stored on the mobile device 102 may augment capability of a standard browser, that supports HTML standard, up to the shoppink browser that enhances view of images and text offered by a webpage on screen of the mobile device. The extracted images may be stored in an image database 130 in the memory 124 of the mobile device 102. The extracted text may be stored in a text database 132 in the memory 124 of the mobile device 102. Further, in an embodiment, the image database 130 and the text database 132 are stored internal to the memory 124 of the mobile device 102. In another embodiment, the image database 130 and the text database 132 may stored external to the mobile device 102.

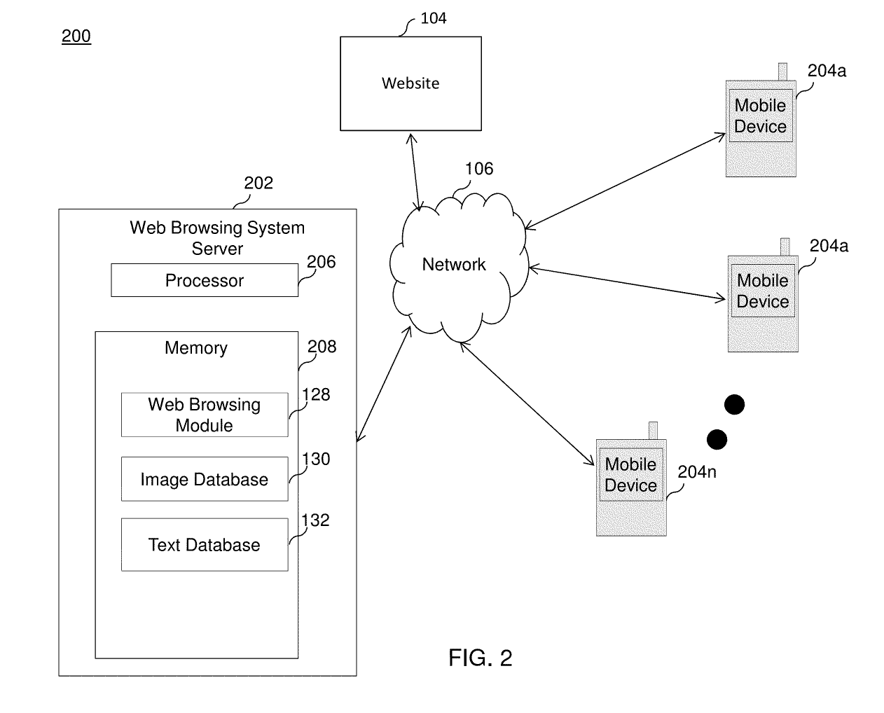

FIG. 2 illustrates another exemplary network environment 200 where various embodiments of the present invention may be implemented. The network environment 200 includes a web browsing system 202 connected to various mobile devices 204a, 204b, . . . 204n (hereinafter referred as 204) via the network 106. The Network 106 may include, but is not restricted to, a communication network such as Internet, PSTN, Local Area Network (LAN), Wide Area Network (WAN), Metropolitan Area Network (MAN), and so forth. In an embodiment, the network 106 can be a data network such as the Internet. Further, the messages exchanged between the web browsing system 202 and the mobile devices 204 can comprise any suitable message format and protocol capable of communicating the information necessary for the web browsing system 202 to provide display of photo album having images and text to the mobile device. Further, the mobile devices 204 may include a web browser that support HTML standard. The mobile devices 204 may utilize the web browsing system 202 to augment functionality of standard browser installed on the mobile device up to functionality of shoppink browser, as provided by the present invention.

FIG. 2 further illustrates exemplary block diagram of a system, such as the web browsing system 202, in accordance with an embodiment of the present invention. In one embodiment, web browsing system 202 may be a computing device. In an embodiment, the web browsing system 202 may be utilized for processing web pages and converting the web pages into image album and text album. The web browsing system 202 includes a processor 206 and a memory 208. In one embodiment, the processor 206 includes a single processor and resides at the web browsing system 202. In another embodiment, the processor 206 may include multiple sub-processors and may reside at the web browsing system as well as the mobile device.

Further, the memory 208 includes one or more instructions that may be executed by the processor 206 to convert web pages into image album and/or text album. In one embodiment, the memory 208 includes the web browsing module 128, the image database 130, the text database 132, and other data (not shown in figure). The other data may include various data generated during processing of conversion of web pages into albums. In one embodiment, the image database 130 and the text database 132 are stored internal to the web browsing system 202. In another embodiment, the image database 130 and the text database 132 may be stored external to the web browsing system 202, and may be accessed via the network 106. Furthermore, the memory 208 of the web browsing system 202 is coupled to the processor 206.

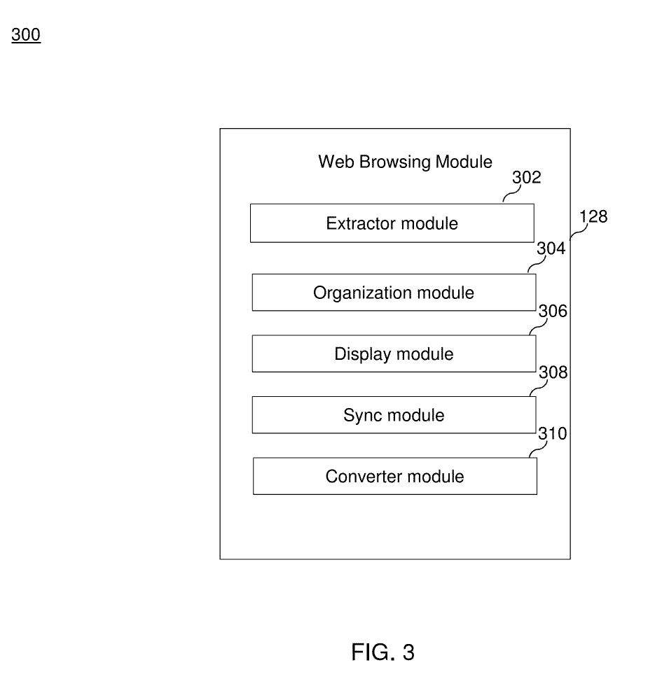

Referring to FIG. 3, the web browsing module 128 includes an extractor module 302, an organization module 304, a display module 306, a sync module 308, and a converter module 310. The web browsing module 128 may convert web pages retrieved from a website into a photo album and store the photo album on the mobile device for display to the user of the mobile device. The photo album may include image album and/or text album.

In operation, a user of the mobile device 102 may access the website 104 via the network 106. In an embodiment, the website 104 is an e-commerce website. The e-commerce website may offer various products. Web pages of the e-commerce website may contain multiple images of the products available for sale and text for description of the multiple images.

In one embodiment, the web browsing module 128 may be stored on the mobile device 102, as described in the description of FIG. 1. The web browsing module 128 may directly receive a web page received from the website 104. The web browsing module 128 may further process the received web page and convert the received web page into a photo album. The photo album may include an image album and/or text album.

In another embodiment, the web browsing module 128 may be stored on a server. For example, as discussed in description of FIG. 2, the web browsing module 128 is stored in the web browsing system server 202. In this embodiment, the web browsing module 128 may receive the web page from the mobile device 204 via the network 106. The web browsing module 128 may further process the received web page and convert the received web page into a photo album. The photo album may include an image album and/or text album. Finally, the web browsing module may send the photo album back to the mobile device 204. In yet another embodiment, some of processing for converting web pages into photo album may be performed at the mobile device 204 and rest of the processing for converting web pages into the photo album may be performed at the web browsing system 202.

The extractor module 302 may extract content of an online document (for example, a web page from an e-commerce website or any other electronic document) according to pre-defined rules. In one embodiment, the extractor module 302 may extract images of the web page. In another embodiment, the extractor module 302 may extract text of the web page. In yet another embodiment, the extractor module 302 may extract both the text and the image available on the web page.

Further, the organization module 304 may organize the extracted content from the web page. The organization module 304 may organize the extracted content into a native photo album. In one embodiment, the native photo album may be saved in the mobile device so that the user may browse it later. The native photo album may include an image album and/or text album. In one embodiment, the organization module 304 may organize the extracted content into the image album. The organization module 304 may organize the extracted images based upon properties of the image. The properties of the image may include aspect ratio, image type, image dimension, and other image information etc. The image album may be stored in the image database 130. In another embodiment, the organization module 304 may organize the extracted content into the text album. The text album may be stored in the text database 132. Further, in an embodiment, the organization module 304 may form a flippable book based on the text album and/or the image album. The flippable book may include pages indication means and content recognition means for example, word count, number of lines, number of pages, unread page count and other useful information/properties of a book.

Next, the display module 306 may display the organized content on a display screen of the mobile device. The organized content may include the native photo album having image album and/or text album. In one embodiment, the display module may utilize the full screen of the mobile device to display the native photo album. In another embodiment, the display module may display the native photo album on a suitable size of the screen based on resolution of the content and a display size of the screen. Those skilled in the art will appreciate that the image or text displayed on the full screen of the mobile device may look clearer than original image or text embedded on the web page.

Further, a sync module 308 may automatically determine whether new content is available on the web pages of the website. In case, the new content is available, the sync module 308 may automatically synchronize the new available content with the extracted content. In one embodiment, the sync module 308 may automatically check for new content on the website at a time interval set by the user. In another embodiment, the sync module 308 may automatically update the extracted content on the mobile device as soon as the new content becomes available on the website.

Furthermore, a converter module 310 may convert the native photo album into a web photo album. In one embodiment, the web photo album so formed may be stored on the web browsing system server 202 and may be accessed by the mobile devices 204 via the network 106. The mobile devices 204 that supports HTML standard may display the web photo album to the users. In another embodiment, the web photo album may be stored on the mobile device 102.

Further, a merchant or owner of e-commerce website may access the native photo album and the web photo album stored on the web browsing system server 202 or the mobile device 102 and may edit the native photo album and the web photo album to add more information for example, product information, price of the product, or any additional information to overwrite the existing converted photo album.

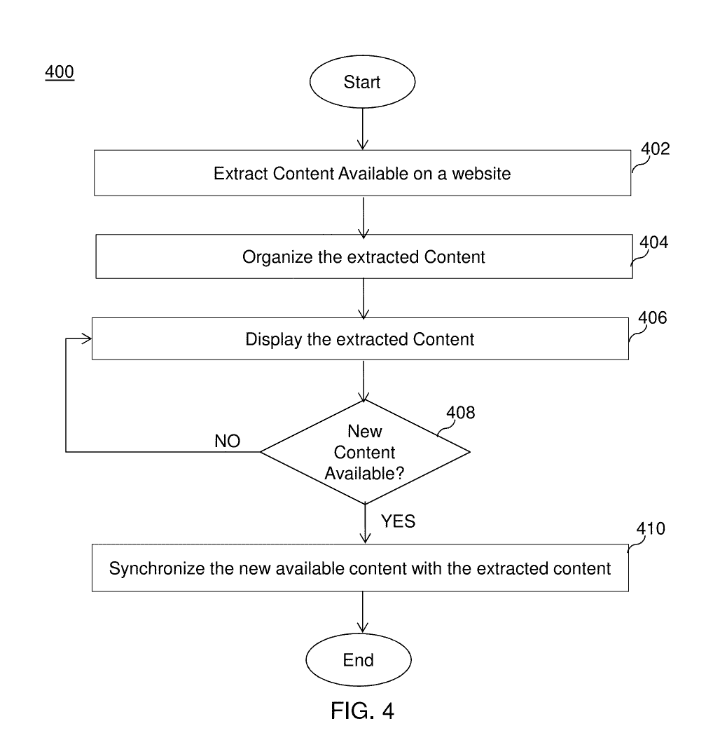

FIG. 4 illustrates a method 400 for converting a web page (for example, web page of an e-commerce website, any online document or any electronic document) into a photo album.

In step 402, content available on a webpage is extracted. In one embodiment, the webpage corresponds to webpage of an e-commerce website. In another embodiment, the webpage may correspond to webpage of any website. Further, in one embodiment, the content may include images. In another embodiment, the content may include text. In yet another embodiment, the content may include both text and image. In an embodiment, the content available on the webpage may be extracted by the extractor module 302.

In step 404, the extracted content is organized. In an embodiment, the content may be organized in a native photo album. In an embodiment, the native photo album may be saved in the mobile device, so that the user may browse it later. The photo album may include an image album and a text album. In one embodiment, the content may be organized in the image album. The extracted images may be organized based upon properties of the images. The properties of the image may include aspect ratio, image type, image dimension, and other image information. In another embodiment, the content may be organized in the text album. Further, the image album or the text album may be organized in form a flippable book. The flippable book includes pages indication means and content recognition means for example, word count, number of lines, number of pages, unread page count and other useful information/properties of a book. In an embodiment, the content may be organized by the organization module 304.

In step 406, the organized content is displayed. The organized content may include the native photo album having image album and/or text album. In one embodiment, full display screen of the mobile device may be utilized to display the native photo album. In another embodiment, a suitable size of the display screen may be utilized based on resolution of the content and a display size of the screen. In an embodiment, the content may be displayed by the display module 306.

In step 408, it is determined whether new content is available on the web pages of the website. If the new content is available on the webpage, the method 400 proceeds to 410. Otherwise, the method returns to 406. In an embodiment, the determination step may be performed by the sync module 308.

In step 410, the new available content is synchronized with the extracted content. In one embodiment, the synchronization the new available content may be performed as soon as the new content is available on the webpage. In another embodiment, the synchronization the new available content may be performed at regular interval set by the user. In an embodiment, the synchronization of the new available content with the extracted content may be done by the sync module 308.

Further, according to an embodiment of the present invention, the native photo album may be converted into a web photo album. The web photo album may be accessed and viewed on the mobile devices that support HTML standard.

Further, the native photo album and the web photo album stored on the mobile device or the server may be accessed by a merchant i.e. an owner of e-commerce website through the network. The native photo album and the web photo album may be manipulated or edited by the merchants to add more information for example, product information, and price of the product or any additional information to overwrite the existing photo album.

The present invention can provide a number of advantages depending on the particular configuration. First, the present invention augments capability of a standard browser installed on the conventional mobile device up to a shoppink browser provided by the present invention. The web browsing module, as provided by the present invention, may be installed on a conventional mobile phone to enhance functionality of conventional browser installed on the mobile device. The shoppink browser may include a toolbar for example; a photo button and/or text button, and a simple click on the photo button and/or text button may trigger the web browsing module to convert webpage into a photo album. The photo album may include image album and/or text album. The photo album thus formed may be displayed on the full screen of the mobile device. Hence, the present invention makes browsing of content like images on a mobile device easier. Further, natural flip style of the mobile device makes browsing of images more effective. Images may also appear bigger and clearer when browsing on the photo album stored on the mobile device.

Further, the present invention fully utilizes screen size of the mobile devices to enhance the browsing of images on the mobile device. The user may see a very clear image in the photo album rather than zooming of web document to view the image.

Furthermore, the present invention facilitates users of the mobile devices to browse through more content at a faster rate. Hence, the present invention provides a technical advancement or technical solution of a technical problem of browsing speed. Hence, more business opportunities can take place on this new browsing platform, i.e. the shoppink browser.

Further, the present invention advantageously converts web pages into photo album in real-time. In one embodiment, the processing may be done on the mobile devices, as depicted in FIG. 1. In another embodiment, the processing may be done on the server for even faster experience, as depicted in FIG. 2.

Furthermore, the present invention facilitates automatic synchronization of the extracted content with the merchant website. Hence, the user of the mobile device may not need to visit the merchant website regularly to check updates for their products. The shoppink browser provided by the present invention may automatically regularly check updates on the merchant website and synchronize the photo album or extracted content with a new available content from the merchant website to keep updated the user. Further, the present invention may send some notification in form of a message or may blink light of the display to notify the user that new available content from the merchant website has come and synchronized with the extracted content.

While the invention has been described in connection with what is presently considered to be the most practical and various embodiments, it is to be understood that the invention is not to be limited to the disclosed embodiments, but on the contrary, is intended to cover various modifications and equivalent arrangements included within the spirit and scope of the appended claims.

This written description uses examples to disclose the invention, including the best mode, and also to enable any person skilled in the art to practice the invention, including making and using any devices or systems and performing any incorporated methods. The patentable scope the invention is defined in the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A web browsing system for mobile devices, comprising:
an extractor module configured to extract content available on a web page; and
a display module configured to display the extracted content.

2. The web browsing system of claim 1, further comprising an organization module configured to organize the extracted content.

3. The web browsing system of claim 2, wherein the organization module is further configured to convert the extracted content into a flippable book.

4. The web browsing system of claim 1, wherein the extracted content comprises images.

5. The web browsing system of claim 1, further comprising a sync module configured to automatically synchronize the extracted content stored on the web browsing system with new content provided by a website.

6. The web browsing system of claim 1, wherein the webpage is downloaded from an e-commerce website.

7. The web browsing system of claim 1, wherein the extractor module is further configured to convert the extracted content from the web page into a native photo album.

8. The web browsing system of claim 7, further comprising a converter module configured to convert the native photo album into a web photo album.

9. The web browsing system of claim 8, wherein the web photo album is browse-able on a mobile device that supports HTML standard.

10. A method for browsing images on a mobile device, the method comprising:
extracting content available on a webpage; and
displaying the extracted content.

11. The method of claim 10, wherein the webpage is downloaded from an e-commerce website.

12. The method of claim 10, further comprising organizing the extracted content based upon a property of the content.

13. The method of claim 10, further comprising converting the extracted content into a native photo album.

14. The method of claim 13, further comprising converting the native photo album into a web photo album.

15. The method of claim 10, further comprising automatically synchronizing extracted content with new available content provided by a website.

16. The method of claim 10, wherein the extracted content comprises text.

17. The method of claim 10, further comprising converting the extracted content into a flippable book.

18. A computer readable medium having computer readable instructions which, when executed by a processor, cause the processor to perform a method comprising:
extracting content available on a webpage; and
displaying the content on a display screen of a mobile device.

19. The computer readable medium of claim 18, further comprising automatically synchronizing extracted content with new content provided by a website.

20. The computer readable medium of claim 18, further comprising converting the extracted content into a flippable book.
